(19) United States
(12) Patent Application Publication
(10) Pub. No.: US 2012/0247441 A1
(43) Pub. Date: Oct. 4, 2012

(54) IGNITION SYSTEM FOR EXTENDING IGNITER LIFE

(75) Inventor: James M. SCHULTZ, Chillicothe, IL (US)

(73) Assignee: Caterpillar Inc.

(21) Appl. No.: 13/077,639

(22) Filed: Mar. 31, 2011

(51) Int. Cl. F02P 9/00

(52) U.S. Cl. 123/609

(57) ABSTRACT

An ignition system for an engine includes an igniter configured to selectively ignite a fuel mixture within the engine, an ignition coil associated with the igniter, and a controller in communication with the ignition coil. The controller is configured to energize the ignition coil during a first ignition sequence until a threshold current has been directed to the ignition coil, measure a rise time associated with reaching the threshold current, and calculate a desired ignition duration based on the rise time and a time margin. The controller is also configured to energize the ignition coil during a second ignition sequence, the second ignition sequence lasting for the desired ignition duration.

### TECHNICAL FIELD

The present disclosure relates generally to an ignition system and, more particularly, to an ignition system using an igniter to initiate combustion.

### BACKGROUND

Engines, including diesel engines, gasoline engines, gaseous fuel powered engines, and other engines known in the art ignite an air/fuel mixture to produce heat. In one example, fuel injected into a combustion chamber of the engine is ignited by way of a spark plug, a glow plug, or an AC/DC ignition source. The heat and expanding gases resulting from this combustion process are directed to displace a piston or move a turbine blade, both of which can be connected to a crankshaft of the engine. As the piston is displaced or the turbine blade is moved, the crankshaft is caused to rotate. This rotation is utilized to directly drive a device such as a transmission to propel a vehicle, or a generator to produce electrical power.

Unfortunately, however, conventional igniters have a relatively short life span in conventional ignition systems and must be replaced often. For example, such ignition systems are typically designed to deliver a fixed amount of energy to the igniter to achieve a spark/ignition duration sufficient to ignite the air/fuel mixture and sustain the flame for the desired combustion. As igniter electrodes corrode/erode over time, the energy needed to maintain the desired ignition duration increases. To compensate for this, the electrical energy delivered to the igniter in conventional systems is typically set to a high level to ensure that the ignition duration requirements are satisfied. Often, the level of energy utilized in conventional systems is greater than necessary to achieve the required spark duration, and such over-energization has the effect of greatly reducing the igniter's useful life.

One attempt at increasing the useful life of igniters is disclosed in U.S. Pat. No. 6,283,103 (the '103 patent), issued to Hoeflich on Sep. 4, 2001. The '103 patent discloses an ignition system including ignition coils that supply energy to spark plugs in an internal combustion engine. The system measures a characteristic indicative of spark duration and generates a representative spark duration signal in response. The system then compares the duration signal to a spark duration setpoint signal, evaluates the error between the two signals, and modulates the energy delivered to each spark plug independently until a desired spark duration is achieved.

Although the system of the '103 patent appears to increase the useful life of its spark plugs, improvements to this system and overall control scheme may still be possible. Specifically, the control strategy disclosed in the ‘103 patent requires varying the voltage of the current directed to the spark plug. Such variations, however, particularly at the high energy levels utilized in modern ignition systems, have been known to cause damage to spark plugs during use. In addition, varying the voltage to maintain a desired spark duration generally requires relatively complex control circuitry and components, thereby increasing the likelihood of system failure.

The disclosed ignition control system is directed to overcoming one or more of the problems set forth above.

### SUMMARY OF THE INVENTION

In an exemplary embodiment of the present disclosure, an ignition system for an engine includes an igniter configured to selectively ignite a fuel mixture within the engine, an ignition coil associated with the igniter, and a controller in communication with the ignition coil. The controller is configured to energize the ignition coil during a first ignition sequence until a threshold current has been directed to the ignition coil, measure a rise time associated with reaching the threshold current, and calculate a desired ignition duration based on the rise time and a time margin. The controller is also configured to energize the ignition coil during a second ignition sequence, the second ignition sequence lasting for the desired ignition duration.

In another exemplary embodiment of the present disclosure, a method of controlling combustion in an engine includes directing electrical current to an ignition coil associated with an igniter during a first ignition sequence until reaching a first current threshold, measuring a rise time indicative of reaching the first current threshold, and calculating a desired ignition duration based on the measured rise time and a time margin. The method also includes directing electrical current to the ignition coil during a second ignition sequence, wherein the second ignition sequence is limited in time to the desired ignition duration.

In a further exemplary embodiment of the present disclosure, a method of limiting ignition duration in an engine includes initiating ignition of a spark plug operatively connected to the engine during a first ignition sequence by selectively directing a flow of electrical current to an ignition coil associated with the spark plug from a direct current source. The method also includes temporarily interrupting the flow of electrical current to the ignition coil in response to reaching a current threshold, calculating a desired ignition duration based on a rise time indicative of reaching the current threshold and a time margin, and resuming the flow of electrical current to the ignition coil for a remainder of the first ignition sequence. In such an exemplary embodiment, the flow of electrical current is temporally modulated for the remainder of the first ignition sequence. The method also includes igniting the spark plug during a second ignition sequence and limiting ignition, during the second ignition sequence, to the desired ignition duration.

### BRIEF DESCRIPTION OF THE DRAWINGS

FIG. 1 is a diagrammatic and schematic illustration of an exemplary disclosed engine;

FIG. 2 is a waveform illustrating ignition coil primary current and igniter voltage versus time for a single ignition sequence according to an exemplary embodiment of the present disclosure;

FIG. 3 is a waveform illustrating igniter voltage versus time for different exemplary ignition durations;

FIG. 4 is an exemplary rise time plot according to an exemplary embodiment of the present disclosure; and

FIG. 5 is a flow chart illustrating a method of controlling combustion and/or limiting ignition duration according to an exemplary embodiment of the present disclosure.

### DETAILED DESCRIPTION

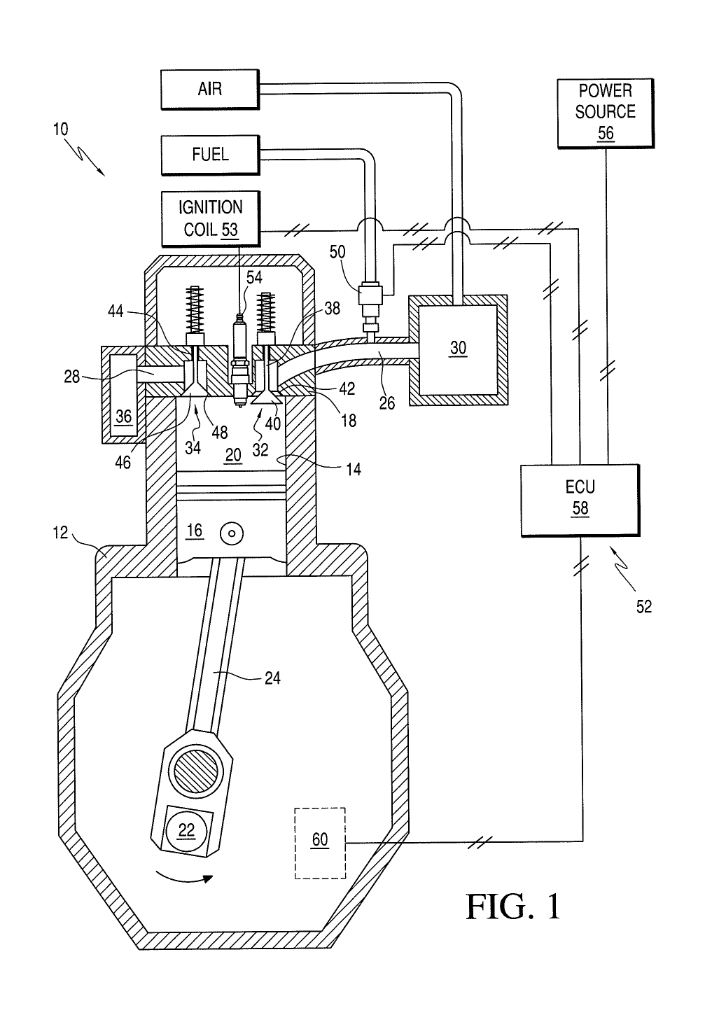

FIG. 1 illustrates an exemplary combustion engine 10. For the purposes of this disclosure, engine 10 will be described as a four-stroke gaseous-fueled engine, for example a natural gas engine. One skilled in the art will recognize, however, that engine 10 may be any other type of combustion engine such as, for example, a gasoline or a diesel-fueled engine. Engine 10 may include an engine block 12 that at least partially defines one or more cylinders 14 (only one shown in FIG. 1). A piston 16 may be slidably disposed within each cylinder 14 to reciprocate between a top-dead-center (TDC) position and a bottom-dead-center (BDC) position, and a cylinder head 18 may be associated with each cylinder 14. Cylinder 14, piston 16, and cylinder head 18 may together define a combustion chamber 20. It is contemplated that engine 10 may include any number of combustion chambers 20 and that combustion chambers 20 may be disposed in an “in-line” configuration, a “V” configuration, or in any other suitable configuration.

Engine 10 may also include a crankshaft 22 that is rotatably disposed within engine block 12. A connecting rod 24 may connect each piston 16 to crankshaft 22 so that a sliding motion of piston 16 between the TDC and BDC positions within each respective cylinder 14 results in a rotation of crankshaft 22. Similarly, a rotation of crankshaft 22 may result in a sliding motion of piston 16 between the TDC and BDC positions. In a four-stroke engine, piston 16 may reciprocate between the TDC and BDC positions through an intake stroke, a compression stroke, a combustion or power stroke, and an exhaust stroke. It is also contemplated that engine 10 may alternatively be a two-stroke engine, wherein a complete cycle includes a compression/exhaust stroke (BDC to TDC) and a power/exhaust/intake stroke (TDC to BDC).

Cylinder head 18 may define an intake passageway 26 and an exhaust passageway 28. Intake passageway 26 may direct compressed air or an air and fuel mixture from an intake manifold 30, through an intake opening 32, and into combustion chamber 20. Exhaust passageway 28 may similarly direct exhaust gases from combustion chamber 20, through an exhaust opening 34, and into an exhaust manifold 36.

An intake valve 38 having a valve element 40 may be disposed within intake opening 32 and configured to selectively engage a seat 42. Valve element 38 may be movable between a first position, at which valve element 40 engages seat 42 to inhibit a flow of fluid relative to intake opening 32, and a second position, at which valve element 40 is removed from seat 42 to allow the flow of fluid.

An exhaust valve 44 having a valve element 46 may be similarly disposed within exhaust opening 34 and configured to selectively engage a seat 48. Valve element 46 may be movable between a first position, at which valve element 46 engages seat 48 to inhibit a flow of fluid relative to exhaust opening 34, and a second position, at which valve element 46 is removed from seat 48 to allow the flow of fluid.

A series of valve actuation assemblies (not shown) may be operatively associated with engine 10 to move valve elements 40 and 46 between the first and second positions. It should be noted that each cylinder head 18 could include multiple intake openings 32 and multiple exhaust openings 34. Each such opening would be associated with either an intake valve element 40 or an exhaust valve element 46. Engine 10 may include a valve actuation assembly for each cylinder head 18 that is configured to actuate all of the intake valves 38 or all of the exhaust valves 44 of that cylinder head 18. It is also contemplated that a single valve actuation assembly could actuate the intake valves 38 or the exhaust valves 44 associated with multiple cylinder heads 18, if desired. The valve actuation assemblies may embody, for example, a cam/push-rod/rocker arm arrangement, a solenoid actuator, a hydraulic actuator, or any other means for actuating known in the art.

A fuel injection device 50 may be associated with engine 10 to direct pressurized fuel into combustion chamber 20. Fuel injection device 50 may embody, for example, an electronic valve situated in communication with intake passageway 26. It is contemplated that injection device 50 could alternatively embody a hydraulically, mechanically, or pneumatically actuated injection device that selectively pressurizes and/or allows pressurized fuel to pass into combustion chamber 20 via intake passageway 26 or in another manner (i.e., directly). The fuel may include a compressed gaseous fuel such as, for example, natural gas, propane, bio-gas, landfill gas, or hydrogen. It is also contemplated that the fuel may be liquefied, for example, gasoline, diesel, methanol, ethanol, or any other liquid fuel, and that an onboard pump (not shown) may be required to pressurize the fuel.

The amount of fuel allowed into intake passageway 26 by injection device 50 may be associated with a ratio of fuel-to-air introduced into combustion chamber 20. Specifically, if it is desired to introduce a lean mixture of fuel and air (mixture having a relatively low amount of fuel compared to the amount of air) into combustion chamber 20, injection device 50 may remain in an injecting position for a shorter period of time (or otherwise be controlled to inject less fuel per given cycle) than if a rich mixture of fuel and air (mixture having a relatively large amount of fuel compared to the amount of air) is desired. Likewise, if a rich mixture of fuel and air is desired, injection device 50 may remain in the injecting position for a longer period of time (or otherwise be controlled to inject more fuel per given cycle) than if a lean mixture is desired.

An ignition system 52 may be associated with engine 10 to help regulate the combustion of the fuel and air mixture within combustion chamber 20 during a series of ignition sequences. Ignition system 52 may include any known ignition components, such as an ignition coil 53, an igniter 54, one or more auxiliary injectors (not shown), a power source 56, and an electronic control unit (ECU) 58. ECU 58 may be configured to regulate operation of such ignition system components based on a stored control strategy and/or in response to input received from one or more sensors 60.

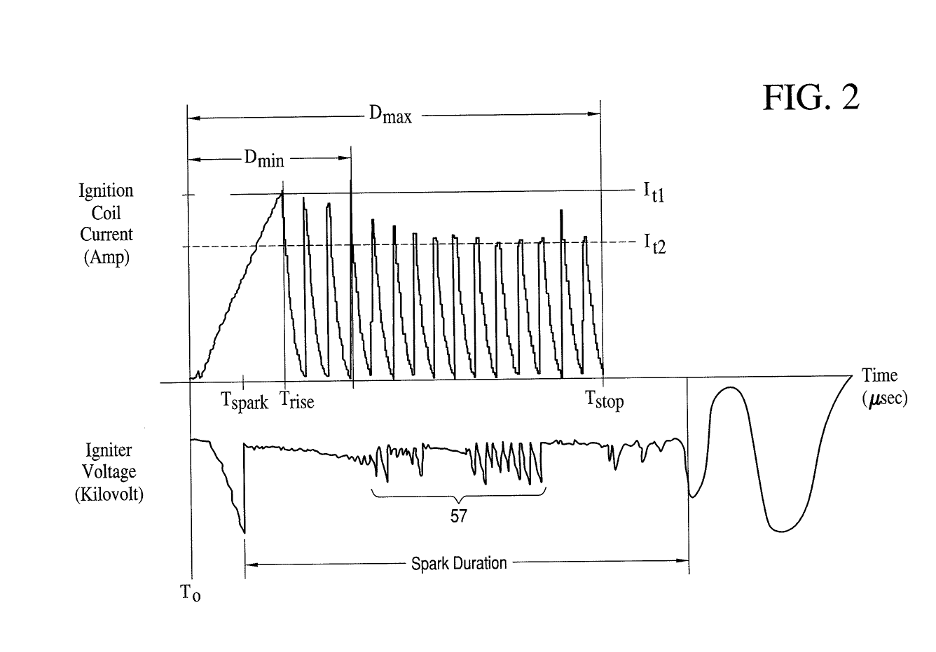

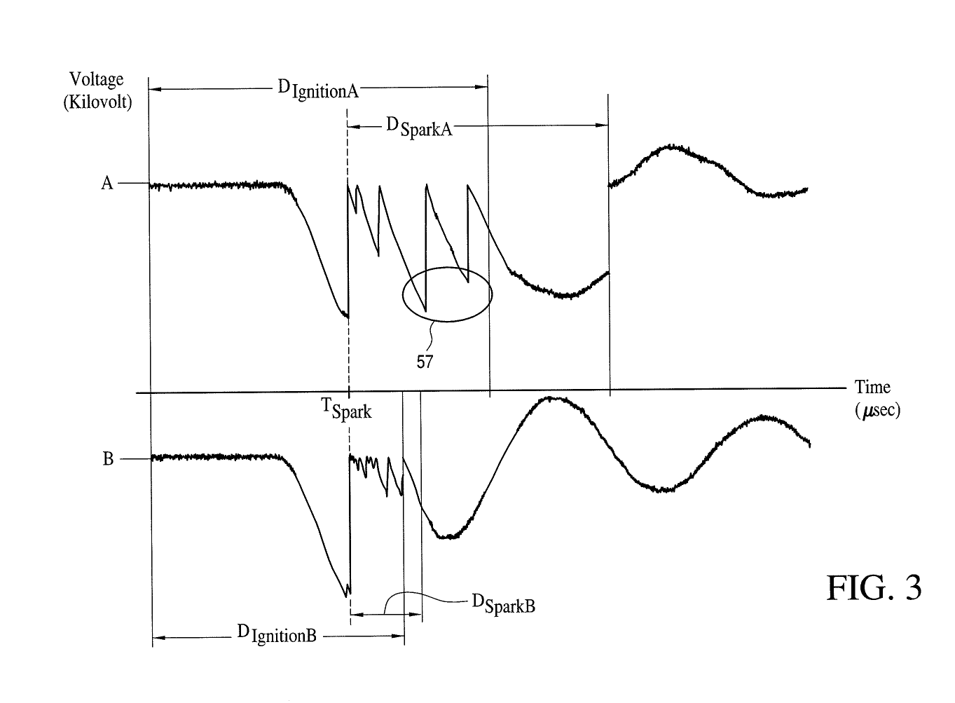

Ignition coil 53 may be operatively connected, electrically coupled, in communication, and/or otherwise associated with the ECU 58, igniter 54, and/or power source 56. The ignition coil 53 may be a separate component of the ignition system 52 or, in additional exemplary embodiments, the ignition coil 53 may be a component of the igniter 54 or other electrical devices included in the ignition system 52. The ignition coil 53 may comprise an inductor, a capacitor, and/or other like electrical devices configured to store electrical energy until such energy is controllably released. Such energy storage and/or discharge characteristics of the ignition coil may result in the characteristics of the waveforms illustrated in FIGS. 2 and 3.

Igniter 54 may facilitate ignition of the fuel and air mixture within combustion chamber 20 during each ignition sequence. Specifically, to initiate combustion of the fuel and air mixture during a startup event or during operation of engine 10, igniter 54 may be energized to locally heat the mixture, thereby creating a flame that propagates throughout combustion chamber 20. The igniter 54 may be energized and/or otherwise ignited by, for example, directing a flow of primary electrical current to the ignition coil 53 at a desired voltage. As the combustion process progresses, the temperature within combustion chamber 20 may continue to rise to a level that supports efficient auto-ignition of the mixture. In one embodiment, igniter 54 may be a spark plug. It is contemplated, however, that igniter 54 may alternatively embody a glow plug, an RF igniter, a laser igniter, or any other type of igniter known in the art.

Power supply 56 may be operably connected to the ECU 58 and configured to supply energy to one or more components of the ignition system 52 and/or other engine components discussed herein. In an exemplary embodiment, the power supply may be a constant voltage, direct current source such as a battery or other like device. In such embodiments, the power supply 56 may embody the battery of the vehicle to which the engine 10 is connected. In alternative exemplary embodiments, however, the power supply 56 may be separate from the vehicle battery and may be, for example, dedicated to supplying power to the ignition system 52. In still further exemplary embodiments, the power supply 56 may be an alternating current source of electrical energy. The power supply 56 may be configured to direct any desired voltage to the components of the ignition system 52 to facilitate operation thereof, and such voltage may be increased and/or decreased by one or more stepper circuits, amplification circuits, and/or other like electrical components. In an exemplary embodiment, the power supply 56 may be configured to provide a direct current to components of the ignition system 52 having a power between approximately 40 Volts and approximately 80 Volts. Such voltages may be, for example, increased to between approximately 90 Volts and 130 Volts, respectively, through the use of known stepper and/or amplification circuitry.

ECU 58 may embody a single or multiple microprocessors, field programmable gate arrays (FPGAs), digital signal processors (DSPs), etc., that include a means for controlling an operation of engine 10 and/or individual engine components. For example, the ECU may be configured to control the ignition coil 53 and/or the igniter 54 based upon a control program stored in a memory of the ECU 58. Such control may be at least partially in response to signals received from sensor 60. Numerous commercially available microprocessors can be configured to perform the functions of ECU 58. It should be appreciated that ECU 58 could readily embody a general engine microprocessor capable of controlling numerous system functions and modes of operation. Various other known circuits may be associated with ECU 58, including power supply circuitry, signal-conditioning circuitry, actuator driver circuitry (i.e., circuitry powering solenoids, motors, or piezo actuators), communication circuitry, timer circuitry, and other appropriate circuitry.

Sensor 60 may be configured to generate a signal indicative of an engine performance parameter. For example, sensor 60 may be disposed proximate to crankshaft 22, and configured to measure and generate a signal indicative of an instantaneous angular position of crankshaft 22. Based on this position, a speed of engine 10 may be derived and used to determine when the operation of engine 10 has transitioned from the first mode to the second mode (i.e., when the speed of engine 10 exceeds a starting speed). The position information may also be used to determine a timing at which igniter 54 is energized. In an exemplary embodiment, the sensor 60 may be a timer configured to measure a length of time for which the ignition coil 53 and/or the igniter 54 has been energized during a given ignition sequence (i.e., an ignition duration) and/or a length of time between initiation of an ignition signal or primary current sent to the ignition coil 53 and the ignition coil 53 reaching a current threshold (i.e., a rise time). It is understood that such a threshold may be predetermined for each ignition sequence. In another example, sensor 60 may be a temperature sensor configured to measure and generate a signal indicative of a temperature of engine 10. In a further example, the sensor 60 may be configured to sense the current and/or voltage of energy directed to the igniter 54 via the power supply 56, the ignition coil 53, and/or the ECU 58. In such an exemplary embodiment, the sensor 60 may be electrically and/or otherwise operably connected to at least one of the ECU 58, the ignition coil 53, the igniter 54, and the power supply 56 to facilitate such sensing. Alternatively, the ECU 58 may further include one or more like sensors or sensor circuitry configured to sense current and/or voltage. It should be noted that other similar sensors are also contemplated, and the ignition systems 52 described herein may include more than one such sensor to facilitate sensing the characteristics discussed above.

### INDUSTRIAL APPLICABILITY

The disclosed ignition system may be applicable to any combustion engine where precise control over combustion initiation is desired. Although particularly suited for use with lean-burn, low-NOₓ producing engines, the disclosed ignition system may be used with any combustion engine during any type of operation. In an exemplary embodiment, the disclosed ignition system 52 may reduce and/or substantially eliminate undesirable operations of the igniter 54 commonly referred to as blowouts or re-arcs. As is known in the art, such blowouts typically occur during an ignition sequence after a spark has been formed by the igniter 54, but while electrical current continues to flow through the igniter 54. Blowouts may be identified, for example, through analysis of voltage waveforms recorded during various ignition sequences, and such exemplary voltage waveforms are illustrated in FIGS. 2 and 3. As shown therein, blowouts may be characterized by sudden dramatic increases in voltage magnitude, followed by subsequent dramatic sharp-edged breakdowns 57 in igniter voltage, after an initial drop in voltage caused by the primary spark formation (occurring at time Tₛₚₐᵣₖ in FIGS. 2 and 3). It is understood that although FIGS. 2 and 3 illustrate production of a negative igniter voltage, in further exemplary embodiments, a positive igniter voltage may be utilized. It is believed that such blowouts create additional wear on igniters 54, resulting in a reduction in the useful life of the igniters 54. Thus, exemplary embodiments of the present disclosure may be useful in minimizing the blowout activity of the igniter 54 by dynamically limiting the overall ignition duration of each ignition event/sequence.

For example, with respect to the exemplary ignition coil current waveform of FIG. 2, an ignition duration of a given ignition sequence (such as the exemplary ignition duration Dₘₐₓ shown in FIG. 2) may be measured from the time T₀ that a flow of electrical current or other initiation signal is sent to the ignition coil 53, until the time Tₛₜₒₚ that such a current is stopped. It is understood that such an ignition duration may be defined as the length of time during which current is directed to a primary winding of the ignition coil 53. As shown in FIG. 2, such an ignition duration is typically shorter than a corresponding spark duration (the length of time during which a resulting spark is generated by the igniter 54).

During the exemplary ignition duration D_{IgnitionA} shown with regard to the voltage waveform A of FIG. 3, the igniter 54 may create a spark starting at the time Tₛₚₐᵣₖ, and the spark may be maintained for a spark duration D_{sparkA} lasting the remainder of the ignition duration D_{IgnitionA} or longer as discussed above. However, the exemplary ignition duration D_{IgnitionA} may be longer than is necessary to promote adequate combustion within the combustion chamber 20 (FIG. 1), and a plurality of breakdowns 57 in the igniter voltage indicative of blowouts may be observed after initiation of the spark at time Tₛₚₐᵣₖ. Accordingly, as illustrated by voltage waveform B of FIG. 3, exemplary embodiments of the present disclosure may assist in reducing the ignition duration D_{IgnitionA} to an ignition duration D_{IgnitionB} ending at an earlier time and lasting a fraction of the ignition duration D_{IgnitionA}. Such an exemplary ignition duration D_{IgnitionB} may still be of sufficient length to support consistent and effective combustion during the respective ignition sequence. However, as shown in FIG. 3, the ignition duration D_{IgnitionB} may avoid the voltage breakdowns 57 characteristic of a lengthier ignition duration D_{IgnitionA}. For example, the ignition duration D_{IgnitionB} may enable a shorter spark duration D_{sparkB}, and since the voltage sent to the ignition coil 53 is held constant during the ignition durations of the present disclosure, shortening the ignition duration causes a corresponding reduction in electrical energy directed to the igniter 54 on a per-ignition sequence basis. By dynamically limiting ignition durations, the exemplary embodiments of the present disclosure may, for each ignition event, avoid harmful blowouts of the igniter and reduce the amount of electrical energy sent to the igniter 54. As a result, such embodiments may extend igniter life without altering the voltage of the electrical current sent to the igniter 54.

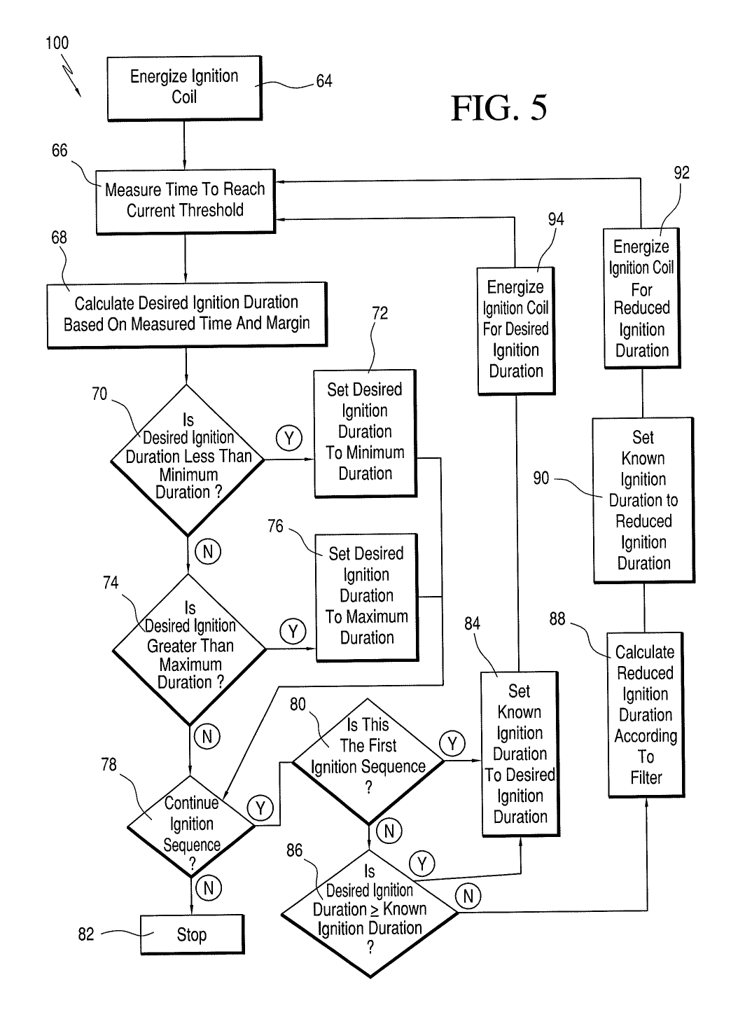

FIG. 2 illustrates an exemplary voltage waveform similar to the waveforms A, B illustrated in FIG. 3. On the same time scale, FIG. 2 also illustrates a corresponding exemplary current waveform. The waveforms of FIG. 2 further illustrate that exemplary control methods of the present disclosure may assist in substantially eliminating undesirable breakdowns 57 in igniter voltage by dynamically limiting ignition duration to be as close to a minimum ignition duration Dₘᵢₙ as possible. The operation of engine 10 will now be explained with respect to, for example, the exemplary embodiment shown in FIG. 1, the exemplary waveforms shown in FIG. 2, and the exemplary flowchart 100 shown in FIG. 5.

During an intake stroke of the engine 10 shown in FIG. 1, as piston 16 is moving within combustion chamber 20 between the TDC position and the BDC position, intake valve 38 may be in the first position, as shown in FIG. 1. During the intake stroke, the downward movement of piston 16 towards the BDC position may create a low-pressure condition within combustion chamber 20. The low-pressure condition may act to draw fuel and air from intake passageway 26 into combustion chamber 20 via intake opening 32. A turbocharger may alternatively be used to force compressed air and fuel into combustion chamber 20. The fuel may be introduced into the air stream either upstream or downstream of the turbocharger or, alternatively, may be injected directly into combustion chamber 20. It is contemplated that the fuel may alternatively be introduced into combustion chamber 20 during a portion of the compression stroke, if desired.

Following the intake stroke, both intake valve 38 and exhaust valve 44 may be in the second position at which the fuel and air mixture is blocked from exiting combustion chamber 20 during the ensuing upward compression stroke of piston 16. As piston 16 moves upward, from the BDC position towards the TDC position during the compression stroke, the fuel and air within combustion chamber 20 may be mixed and compressed. At a time during the compression stroke or, alternatively, just after completion of the compression stroke, combustion of the compressed mixture may be initiated.

As described above, ECU 58 may initiate combustion by energizing one or more components of the ignition system 52, such as the ignition coil 53 and/or the igniter 54 (Step: 64). For example, the ECU 58 may direct an electrical current from the power source 56 to the ignition coil 53 in order to generate a spark at the igniter 54 to locally heat the now compressed fuel and air mixture. This local heating may result in a flame that propagates throughout combustion chamber 20, thereby selectively igniting the remaining fuel and air mixture within the engine 10.

As shown in FIG. 2, the electrical current sent to the ignition coil 53 may rise substantially steadily beginning from time T₀ through time Tᵣᵢₛₑ. In an exemplary embodiment, the flow of current sent to the ignition coil 53 may steadily increase until a threshold current Iₜ₁ is reached. In an exemplary embodiment, the threshold current Iₜ₁ may be a predetermined threshold in the range of approximately 15 Amps to approximately 40 Amps. In a further exemplary embodiment, the threshold current Iₜ₁ may be equal to approximately 17 Amps. Such an exemplary threshold may be determined and/or otherwise varied depending upon the various configurations of the engine 10 and/or engine components. For example, such a threshold may be determined through experimentation based upon the minimum acceptable current required to initiate combustion within the combustion chamber 20. In such exemplary embodiments, the factors considered in determining such a threshold may include, for example, engine size, engine load, ignition coil type, power source type, igniter type, and/or other known ignition system 52 and/or engine 10 specifications.

As shown in FIG. 2, a substantially constantly increasing direct current may be directed to the igniter 54 and/or the ignition coil 53 until the threshold Iₜ₁ has been reached, and upon reaching the threshold Iₜ₁, the ECU 58 may temporarily cut off, interrupt, and/or otherwise prohibit current from flowing to the ignition coil 53. The ECU 58, and/or a sensor 60 associated therewith, may measure the length of time Tᵣᵢₛₑ associated with and/or otherwise indicative of reaching the current threshold Iₜ₁ (Step: 66). It is understood that such a rise time Tᵣᵢₛₑ may vary depending on, for example, a type and/or size of the ignition coil 53, a size of the igniter 54, engine load, combustion cylinder pressure, combustion cylinder temperature, and/or other characteristics of the engine 10 and/or ignition system 52. For example, an engine 10 having a relatively low compression ratio and/or combustion chamber pressure may be characterized by a relatively shorter rise time Tᵣᵢₛₑ than a similar engine 10 having a relatively higher compression ratio and/or combustion chamber pressure. It is also possible that such a rise time Tᵣᵢₛₑ may increase as the engine 10 and/or the components of the ignition system 52 age. For example, older igniters 54 may have a larger gap size and a corresponding longer rise time Tᵣᵢₛₑ than like newer igniters 54.

As shown in FIG. 2, while a substantially constantly increasing direct current is being directed to the ignition coil 53, between time T₀ and time Tᵣᵢₛₑ, the voltage measured at the igniter 54 may decrease until a spark is formed by the igniter 54 at time Tₛₚₐᵣₖ. It is understood that the spark may be formed by the igniter 54 before the current reaches the current threshold Iₜ₁. It is also understood that, as illustrated by the voltage waveform of FIG. 2, initiation of such a spark at time Tₛₚₐᵣₖ may be characterized by an abrupt increase in the voltage at the ignition coil 53 and/or other components of the ignition system 52. Moreover, an exemplary spark duration may extend from the time Tₛₚₐᵣₖ until a time after the flow of current to the ignition coil 53 has been cut off (Tₛₜₒₚ).

The ECU 58 may utilize the measured rise time Tᵣᵢₛₑ to calculate and/or otherwise determine a desired ignition duration (Step: 68). For example, the ECU 58 may calculate the desired ignition duration based on the rise time Tᵣᵢₛₑ and a time margin, and the desired ignition duration calculated by the ECU 58 may be utilized by the ECU 58 to limit the duration of a next and/or subsequent ignition sequence. For example, wherein the waveforms of FIG. 2 are illustrative of an initial and/or first ignition sequence of the igniter 54, a second ignition sequence following the first ignition sequence may be limited in time to the desired ignition duration calculated at Step 68.

In an exemplary embodiment, the desired ignition duration may be calculated at Step 68 by summing the measured rise time Tᵣᵢₛₑ and the time margin discussed above. In such an exemplary embodiment, the time margin may be determined based on one or more characteristics of the engine 10 and/or ignition system 52. For example, as discussed above with regard to the rise time Tᵣᵢₛₑ, factors such as igniter type, ignition coil type, engine load, and/or other known operating conditions and/or ignition system component characteristics may be considered in determining the time margin. For example, the time margin may be chosen and/or otherwise set in order to ensure that current is sent to the igniter 54 for a period of time long enough to initiate the spark.

In an exemplary embodiment, the time margin discussed above may be selected based on a desired minimum ignition duration Dₘᵢₙ corresponding to the engine 10, the ignition coil 53, and/or the igniter 54. For example, the minimum ignition duration Dₘᵢₙ may be selected, through experimentation, based on the minimum length of time required for the engine 10 to achieve substantially complete combustion within the combustion chamber 20 without misfires and/or other known indicators of unsatisfactory operating conditions. In an exemplary embodiment, the minimum ignition duration may be between approximately 100 μs and approximately 200 μs. In further exemplary embodiments, the minimum ignition duration Dₘᵢₙ may be equal to, approximately, 150 μs. Once such an exemplary minimum ignition duration Dₘᵢₙ is chosen, a corresponding time margin may be selected to ensure that, for a given igniter 54 and a corresponding expected time Tₛₚₐᵣₖ until spark initiation, electrical current is directed to the ignition coil 53 and/or the igniter 54 for at least the minimum ignition duration Dₘᵢₙ. For example, if a minimum ignition duration Dₘᵢₙ equal to 150 μs is chosen, and the expected time Tₛₚₐᵣₖ to initiate a spark with the igniter 54 is expected to be 100 μs, the chosen time margin may be 50 μs such that electrical current may be directed to the ignition coil 53 and/or the igniter 54 for at least the minimum ignition duration Dₘᵢₙ during the exemplary ignition sequence. Although an exemplary time margin of 50 μs has been described above, it is understood that in further exemplary embodiments, any other suitable time margin may be chosen.

Once the desired ignition duration has been calculated, the ignition duration may be compared to a known, desired, and/or predetermined ignition duration range. Such an ignition duration range may be between, for example, the minimum ignition duration Dₘᵢₙ discussed above and a corresponding maximum ignition duration Dₘₐₓ of the engine 10. Such an exemplary maximum ignition duration Dₘₐₓ may be indicative of a maximum permissible length of time during which ignition may be tolerated within the combustion chamber 20 of the engine 10. Such a maximum ignition duration Dₘₐₓ may be chosen based on, for example, the same factors discussed above with regard to the minimum ignition duration Dₘᵢₙ. Such a maximum ignition duration Dₘₐₓ may be chosen to desirably limit wear on, for example, electrodes and/or other components of the igniter 54. In further exemplary embodiments, the maximum ignition duration Dₘₐₓ may be chosen based on one or more limitations of the ignition system components and/or the energy capabilities of the ECU 58. In an exemplary embodiments, the maximum ignition duration Dₘₐₓ may be between, for example, 300 μs and approximately 2000 μs. In further exemplary embodiments, the maximum ignition duration Dₘₐₓ may be, approximately, 400 μs.

At Step 70, the ECU 58 may determine whether the desired ignition duration is less than the minimum ignition duration Dₘᵢₙ. If so, the desired ignition duration may be set to the minimum ignition duration Dₘᵢₙ (Step: 72). In this way, the desired ignition duration utilized to limit a next and/or subsequent ignition sequence may last for at least the minimum ignition duration Dₘᵢₙ even if the desired ignition duration is calculated to be less than such a minimum.

The ECU 58 may also determine whether the desired ignition duration is greater than the maximum ignition duration Dₘₐₓ (Step: 74). If so, the desired ignition duration calculated at Step 68 may be set to the maximum ignition duration Dₘₐₓ (Step: 76). In this way, even if the desired ignition duration calculated at Step 68 is greater than the known maximum ignition duration Dₘₐₓ, the next and/or subsequent ignition sequence will be limited to the maximum ignition duration Dₘₐₓ.

The ECU may also determine whether, for example, the engine operator and/or other users of the exemplary method illustrated in the flow chart 100 wish to continue the present ignition sequence (Step: 78). It is understood that such a determination may be made earlier and/or later in the control strategy illustrated by the flow chart 100. If the ECU 58 determines that the present ignition sequence is not to be continued, ECU 58 may, for example, stop directing current to the ignition coil 53 and/or the igniter 54, and may otherwise end the present ignition sequence (Step: 82).

If, however, the present ignition sequence is to continue, the ECU 58 may determine whether or not the present ignition sequence is the first ignition sequence performed by components of the ignition system 52 (Step: 80). For example, the ECU 58 may determine whether the present ignition sequence is a first ignition sequence performed by the ignition system 52 associated with start up of the engine 10. If the present ignition sequence is the first ignition sequence associated with start up, the ECU 58 may set a value of an ignition parameter for future comparison purposes. For example, upon determining that the present ignition sequence is a first ignition sequence of the ignition system 52, the ECU 58 may set the value of a known ignition duration (or other comparison parameter). The value of such a parameter may be set to, for example, the desired ignition duration values as calculated at Step 68 and/or as modified at previous Steps 72, 76 (Step: 84). By setting the known ignition duration to the desired ignition duration, the known ignition duration may be utilized for comparison purposes during a next and/or subsequent ignition sequence performed by the ignition system 52.

As shown in FIG. 5, the ECU 58 may energize the ignition coil 53 and/or the igniter 54 for the desired ignition duration during a second ignition sequence (Step: 94). In exemplary embodiments of the present disclosure, the second ignition sequence may be a next ignition sequence and/or a subsequent ignition sequence. In this way, such a second ignition sequence may be limited in time to the desired ignition duration calculated during the previous sequence. The control method may then return to Step 66. It is also understood that while a second ignition sequence may be limited to the desired ignition duration calculated during a first ignition sequence, the duration of the first ignition sequence may be limited in time in any known way. For example, although not expressly shown in FIG. 5, it is understood that the first and/or initial ignition sequence may be limited in time to the minimum ignition duration Dₘᵢₙ, the maximum ignition duration Dₘₐₓ, and/or any other desired duration.

If the ECU 58 determines that the present ignition sequence is not the first ignition sequence, the ECU 58 may compare, for example, the desired ignition duration to the known parameter previously set during Step 84. For example, the ECU 58 may determine whether the desired ignition duration is greater than or equal to the known ignition duration set at Step 84 (Step: 86). If the desired ignition duration is calculated to be greater than or equal to the known ignition duration set at Step 84 during, for example, the first and/or previous ignition sequence, the ECU 58 may set the known ignition duration equal to the desired ignition duration at Step 84, and may utilize the desired ignition duration to limit the second ignition sequence. In this way, the exemplary systems and/or methods of the present disclosure may respond rapidly to increases in, for example, engine load and/or other parameters characterized by an increase in rise time Tᵣᵢₛₑ.

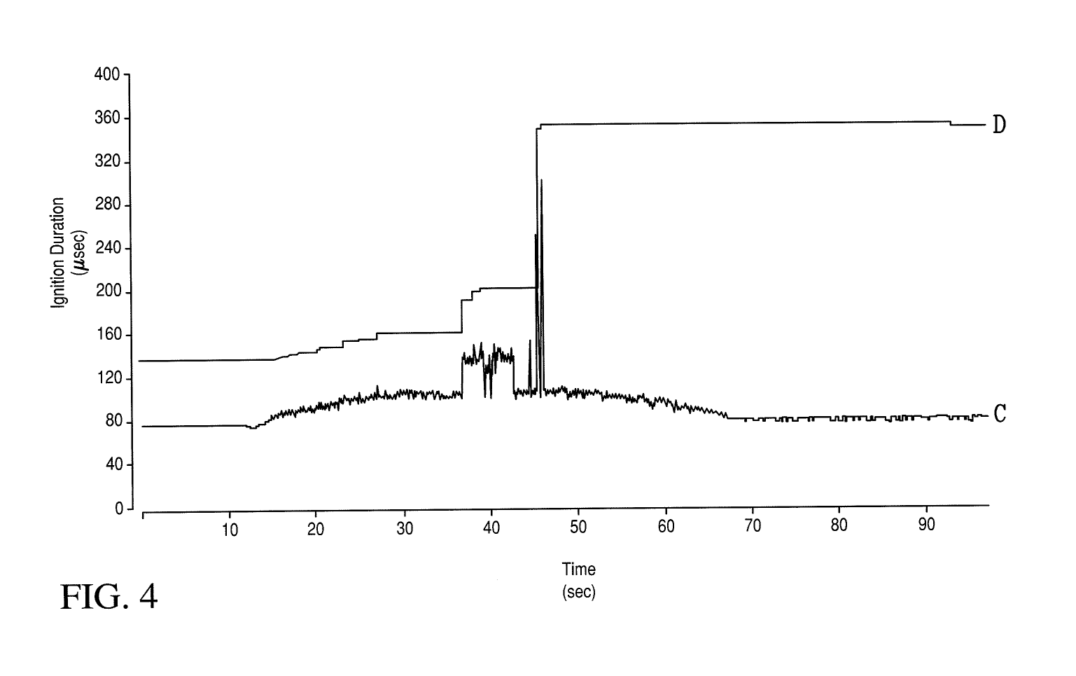

For example, as illustrated in FIG. 4, increases in actual rise time shown by ignition rise time plot C may cause a substantially immediate corresponding increase in the desired ignition duration calculated at Step 68 and/or modified at Steps 72, 76. Such increases are shown, for example, between 35 seconds and 50 seconds on the calculated ignition duration plot D. Such rapid responses to actual increases in ignition duration may assist in ensuring proper operation of the engine 10 over a series of ignition sequences.

If, however, the desired ignition duration is calculated to be less than the known ignition duration, exemplary systems and/or methods of the present disclosure may utilize a response filter configured to relatively slowly decrease next and/or subsequent ignition sequence durations. The ECU 58 may calculate a reduced ignition duration according to the response filter (Step: 88) in response to such a determination.

For example, if a desired ignition duration is equal to approximately 190 μs, and a known and/or previous ignition duration was equal to approximately 200 μs, the ECU 58 may calculate a reduced ignition duration at Step 88 in order to relatively slowly decrease the ignition duration utilized during the next ignition sequence. In such an exemplary embodiment, the reduction filter may utilize any desired range of reduction factors to calculate the reduced ignition duration. For example, such reduction factors may be between approximately 50 μs/hr and approximately 1200 μs/hr, and in a further exemplary embodiments, such a reduction factor may be approximately 100 μs/hr. As a result of this relatively slow response to decreases in ignition duration, embodiments of the present disclosure may assist in ensuring, for example, completion of combustion within the combustion chamber 20. Such an exemplary response to decreases in ignition duration can be seen between, for example, on rise time plot C between 45 seconds and 50 seconds in FIG. 4. During this time range, the exemplary rise time plot C exhibits a sharp decline in rise time, while the corresponding calculated ignition duration plot D exhibits a relatively slow corresponding decline in response.

Upon calculating the reduced ignition duration at Step 88, the ECU 58 may set the known ignition duration to the calculated reduced ignition duration (Step: 90) and may energize the ignition coil 53 and/or the igniter 54 for the reduced ignition duration during a second ignition sequence (Step: 92). The ECU 58 and/or sensor 60 may then return to Step 66. The process illustrated in flowchart 100 may be repeated for a series of ignition sequences, and the desired ignition duration may be dynamically controlled and/or modified, on a per-ignition sequence basis, in accordance with the steps shown in flowchart 100. Such exemplary methods and systems may assist in dynamically limiting ignition duration, on a per-ignition sequence basis, to avoid re-arcing and/or blowouts, and to reduce the overall energy directed to the igniter 54. As a result, a longer life span of the igniter 54 may be achieved without varying the voltage directed thereto.

Referring again to FIG. 2, in additional exemplary embodiments, once the current directed to the ignition coil 53 has reached the first current threshold Iₜ₁ the ECU 58 may utilize a different current threshold Iₜ₂ for at least a portion of the remainder of the ignition sequence. In an exemplary embodiment, the second and/or different ignition threshold Iₜ₂ may be greater than the initial and/or first current threshold Iₜ₂. As shown in FIG. 2, in additional exemplary embodiments, the second current threshold Iₜ₂ may be less than the first current threshold Iₜ₁.

Moreover, as shown by the waveform of FIG. 2, the current directed to the ignition coil 53 may have any desirable temporal modulation known in the art. Such temporal modulations may begin, for example, after Tᵣᵢₛₑ and/or upon resuming the flow of electrical current to the ignition coil 53. The electrical current may be modulated for a remainder of the respective ignition sequence upon reaching the first current threshold Iₜ₁ at Tᵣᵢₛₑ. As is also illustrated by the waveform of FIG. 2, the current directed to the ignition coil 53 may be ramped down and/or ramped up to the second current threshold Iₜ₂ at any known rate upon reaching the first current threshold Iₜ₁. Such temporal modulations may result from, for example, repeatedly temporarily prohibiting and/or interrupting the flow of electrical current to the ignition coil 53 in response to reaching one or more of the current thresholds described herein.

It will be apparent to those skilled in the art that various modifications and variations can be made to the disclosed ignition system. Other embodiments will be apparent to those skilled in the art from consideration of the specification and practice of the disclosed ignition system. It is intended that the specification and examples be considered as exemplary only, with a true scope being indicated by the following claims and their equivalents.

What is claimed is:

1. An ignition system for an engine, comprising:
an igniter configured to selectively ignite a fuel mixture within the engine
an ignition coil associated with the igniter; and
a controller in communication with the ignition coil, the controller being configured to
energize the ignition coil during a first ignition sequence until a threshold current has been directed to the ignition coil,
measure a rise time associated with reaching the threshold current,
calculate a desired ignition duration based on the rise time and a time margin, and
energize the ignition coil during a second ignition sequence, the second ignition sequence lasting for the desired ignition duration.

2. The ignition system of claim 1, wherein the first ignition sequence is associated with startup of the engine.

3. The ignition system of claim 1, wherein the igniter comprises a spark plug.

4. The ignition system of claim 1, further comprising a constant voltage power source operably connected to the controller and configured to assist in energizing the ignition coil.

5. The ignition system of claim 1, wherein the controller is configured to compare the desired ignition duration to an ignition duration range, and to modify the desired ignition duration based on the comparison.

6. A method of controlling combustion in an engine, comprising:
directing electrical current to an ignition coil associated with an igniter during a first ignition sequence until reaching a first current threshold;
measuring a rise time indicative of reaching the first current threshold;
calculating a desired ignition duration based on the measured rise time and a time margin; and
directing electrical current to the ignition coil during a second ignition sequence, wherein the second ignition sequence is limited in time to the desired ignition duration.

7. The method of claim 6, wherein the first ignition sequence is associated with startup of the engine.

8. The method of claim 6, further comprising determining that the desired ignition duration is less than a minimum ignition duration, and limiting the duration of the second ignition sequence to the minimum ignition duration in response to the determination.

9. The method of claim 6, further comprising determining that the desired ignition duration is greater than a maximum ignition duration, and limiting the duration of the second ignition sequence to the maximum ignition duration in response to the determination.

10. The method of claim 6, further comprising comparing the desired ignition duration to a previous ignition duration, and limiting the duration of the second ignition sequence to the desired ignition duration based on the comparison.

11. The method of claim 6, further comprising comparing the desired ignition duration to a previous ignition duration, calculating a reduced ignition duration based on the comparison, and limiting the duration of the second ignition sequence to the reduced ignition duration in response to the comparison.

12. The method of claim 6, wherein the electrical current directed to the ignition coil during the first ignition sequence is characterized by a constant voltage.

13. The method of claim 6, wherein the first current threshold is equal to approximately 17 amps.

14. The method of claim 6, wherein the time margin is selected based on a minimum ignition duration and an expected rise time of the ignition coil.

15. The method of claim 6, further comprising temporally modulating the electrical current directed to the ignition coil for a remainder of the first ignition sequence after reaching the first current threshold.

16. The method of claim 15, further comprising limiting the modulated electrical current to a second current threshold, different than the first current threshold, during the remainder of the first ignition sequence.

17. The method of claim 6, wherein limiting the second ignition sequence to the desired ignition duration substantially eliminates igniter blowouts during the second ignition sequence.

18. A method of limiting ignition duration in an engine, comprising:
initiating ignition of a spark plug operatively connected to the engine during a first ignition sequence by selectively directing a flow of electrical current to an ignition coil associated with the spark plug from a direct current source;
temporarily interrupting the flow of electrical current to the ignition coil in response to reaching a current threshold;
calculating a desired ignition duration based on a rise time indicative of reaching the current threshold and a time margin;
resuming the flow of electrical current to the ignition coil for a remainder of the first ignition sequence, wherein the flow of electrical current is temporally modulated for the remainder of the first ignition sequence; and
igniting the spark plug during a second ignition sequence and limiting ignition, during the second ignition sequence, to the desired ignition duration.

19. The method of claim 18, further comprising comparing the desired ignition duration to a previous ignition duration and igniting the spark plug for a reduced ignition duration based on the comparison.

20. The method of claim 18, further comprising comparing the desired ignition duration to a duration range and modifying the desired ignition duration based on the comparison.
